(19) United States
(12) Patent Application Publication
(10) Pub. No.: US 2026/0154154 A1
(43) Pub. Date: Jun. 4, 2026

(54) CORRECTING ERRORS IN A MEMORY DEVICE

(71) Applicant: Mellanox Technologies, Ltd., Yokneam (IL)

(72) Inventor: Rami Zecharia, Yokneam (IL)

(21) Appl. No.: 18/965,865

(22) Filed: Dec. 2, 2024

(51) Int. Cl. G06F 11/10

(52) U.S. Cl. CPC G06F 11/1068; G06F 11/1016

(57) ABSTRACT

A memory device includes memory locations, a register, and hardware logic. The hardware logic is to receive a first set of data bits to be stored at a first location of the plurality of memory locations, determine values of a set of code bits based on the first set of data bits, write the first set of data bits and the set of code bits to the first location as first data, and determine, using the first data and first cumulative error data stored in the first register, second cumulative error data. The first cumulative error data reflects previous data stored at the plurality of memory locations at a first time. The hardware logic further to overwrite the first cumulative error data in the first register with the second cumulative error data.

### TECHNICAL FIELD

At least one embodiment pertains to correcting errors in memory. For example, at least one embodiment pertains to correcting errors in a memory device.

### BACKGROUND

In certain memory systems, data can be written to memory with redundancy data. The redundancy data, such as error correction code (ECC) data) can be used to detect and correct errors in data that is written to the memory.

### BRIEF DESCRIPTION OF DRAWINGS

Various embodiments in accordance with aspects of the disclosure will be described with reference to the drawings, in which:

FIG. 1 is a block diagram of a communication interconnect, according to some aspects of the disclosure.

FIG. 2A is an example block diagram of a memory device coupled to an error correction module, according to some aspects of the disclosure.

FIG. 2B is an example table of entries in the memory block, according to some aspects of the disclosure.

FIG. 3A illustrates an example memory block entry table and corresponding XOR register, according to some aspects of the disclosure.

FIG. 3B illustrates an example memory block entry table, corresponding XOR register, and secondary register, according to some aspects of the disclosure.

FIG. 3C illustrates an example XOR register and secondary register, according to some aspects of the disclosure.

FIG. 3D illustrates an example memory block entry table, XOR register, and secondary register, according to some aspects of the disclosure.

FIG. 4 is a flow diagram of an example method for correcting errors in a memory device, according to aspects of the disclosure.

FIG. 5A is a flow diagram of an example method for correcting errors in a memory device, according to aspects of the disclosure.

FIG. 5B is a flow diagram of an example method for correcting errors in a memory device, according to aspects of the disclosure.

FIG. 6 is a block diagram illustrating an exemplary computer system which can be a system with interconnected devices and components, a system-on-a-chip (SOC), or some combination thereof, according to aspects of the disclosure.

FIG. 7 is a block diagram illustrating an electronic device for utilizing a processor, according to aspects of the disclosure.

FIG. 8 is a block diagram of a processing system, according to aspects of the disclosure.

FIG. 9 is a block diagram of a computing system having two processing devices coupled to each other and multiple networks according to some aspects of the disclosure.

FIG. 10 is a block diagram of a computing system having a CPU and a GPU in a single integrated circuit according to some aspects of the disclosure.

FIG. 11 is a block diagram of a computing system having tensor core GPUs according to some aspects of the disclosure.

### DETAILED DESCRIPTION

Data can be processed by multiple coupled integrated circuits (ICs) that may each perform different—sometimes specialized-functions. Often these ICs are colloquially referred to as ‘chips,’ with reference to the final stages of the semiconductor manufacturing process where the ICs (e.g., the chips) are cut from a larger semiconductor wafer. The ICs can be packaged with necessary input/output (I/O) connections, and other circuitry and the resulting apparatus can be referred to as a ‘chip.’ Thus, a ‘communication interconnect’ or ‘chip-to-chip (C2C) interconnect’ can describe an electrical and data coupling (e.g., interconnect) between at least two distinct chips (e.g., ICs). An unpackaged IC that has been cut from a larger semiconductor wafer can be colloquially referred to as a ‘die.’ Thus, a ‘communication interconnect’ or ‘die-to-die (D2D) interconnect’ can describe an electrical and data coupling (e.g., interconnect) between at least two distinct dies (e.g., ICs).

These chips, dies, and interconnects can include one or more electrical circuits. Data that is transmitted by these electrical circuits may be affected by transient faults in the electrical circuits, resulting in soft errors in the transmitted data. These transient faults may also affect memory storage circuits, which can similarly experience soft errors. As used herein, “soft errors” refer to errors in data which are caused by an external interference that does not damage physical hardware. For example, soft errors can be caused by environmental factors such as cosmic rays, radiation from alpha particles, or electromagnetic interference. When data signals pass through a semiconductor, the data signals can create electron-hole pairs that can accumulate as a charge within the electronic circuit, causing an inadvertent bit flip or change in logic state of the transmitted data signal. Soft errors are more likely to occur in high-density electrical circuits such as memory storage devices, such as registers or memory cells in static random-access memory (SRAM), dynamic random-access memory (DRAM), or embedded memory. The frequency of soft errors varies depending on the technology, environment, and preventative measures used in the design of the electrical circuits.

Often, the effectiveness of an error correction technique is limited to the number of bits that are allocated to a selected error correction technique. Increasing the bit allocation for an error correction technique enhances its ability to detect and correct errors, improving overall data integrity. However, a larger bit count can require additional processing resources and can occupy a larger silicon footprint. Conversely, a reduced bit allocation for an error correction technique may limit the effectiveness of the error correction technique, compromising data reliability in exchange for a lower processing resource requirement and smaller silicon footprint.

One approach to protect against soft errors is by using error correction code (ECC). ECC uses a specific algorithm to generate extra bits based on the original data. When the data is later read or retrieved, the system checks these additional bits to detect any discrepancies. If errors are found, the ECC algorithm can correct the errors. One commonly used type of ECC is single error correction double error detection (SEC-DED). In SEC-DED, the number of code bits C required to protect data bits D can be calculated as C=┌log₂D┐+1. It can be appreciated that as the number of data bits D increases, the number of code bits C can similarly increase.

Protected memory, such as SRAM or DRAM can contain error correcting bits for each entry in the memory device. For example, an protected 1000×32 memory device (one thousand entries of 32 bits each), can include an additional 6 code bits for each entry, such that the memory becomes a 1000×38 memory device (e.g., one thousand entries of 38 bits each). The additional six error correcting bits for each entry of the 1000×38 can protects each entry from one soft error, and allow the detection of a maximum of two soft errors.

When the computing device reads from the memory, the data bits at the given memory address are checked for errors. If an error is detected, the computing device can attempt to correct the error using the error correcting bits. If the computing device is unable to correct the error with error correcting bits, the computing device may cause the data bits at the given memory address to be rewritten, or may cause the entire memory device to be reset to a default state. Both rewriting and resetting the device can take a relatively long time and waste processing resources.

Aspects of this disclosure address these and other challenges by implementing correcting errors in a memory device. A memory device can store multiple entries of data. Each time new data is to be written to the memory device, the memory device determines a new a value of cumulative error data. The cumulative error data is determined based on the previous cumulative error data and the new data to be written to the memory device. The cumulative error data is stored in a register on the memory device. When a memory error is detected (e.g., a soft error), the cumulative error data can be used to correct the memory error.

Advantages of the disclosure include, but are not limited to, a reduced energy consumption of the memory device, reduced memory latency, increased performance of the memory device, and increased data integrity of data stored at the memory device.

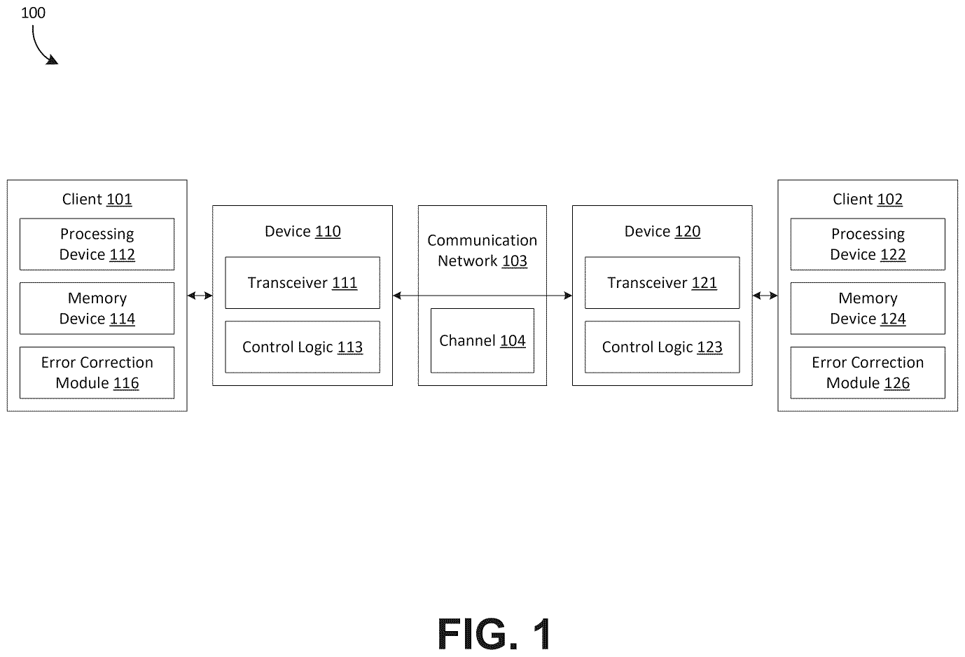

FIG. 1 is a block diagram of a communication interconnect 100, according to some aspects of the disclosure. The communication interconnect 100 includes a client 101 coupled to a device 110 and a client 102 coupled to a device 120. The device 110 and the device 120 are coupled together a communication network 103 to transmit and receive data across the channel 104. In some embodiments, the transmitted and received data is included in a data frame. Device 110 includes a transceiver 111 configured to send and receive data signals via a channel 104 of the communication network 103. Device 120 similarly includes a transceiver 121 configured to send and receive data signals via a channel 104 of the communication network 103.

In some embodiments, the client 101 is an integrated circuit of a Personal Computer (PC), a laptop, a tablet, a smartphone, a server, a collection of servers, or the like. In some embodiments, the client 101 may correspond to any appropriate type of device that communicates with other devices also connected to a common type of communication network 103.

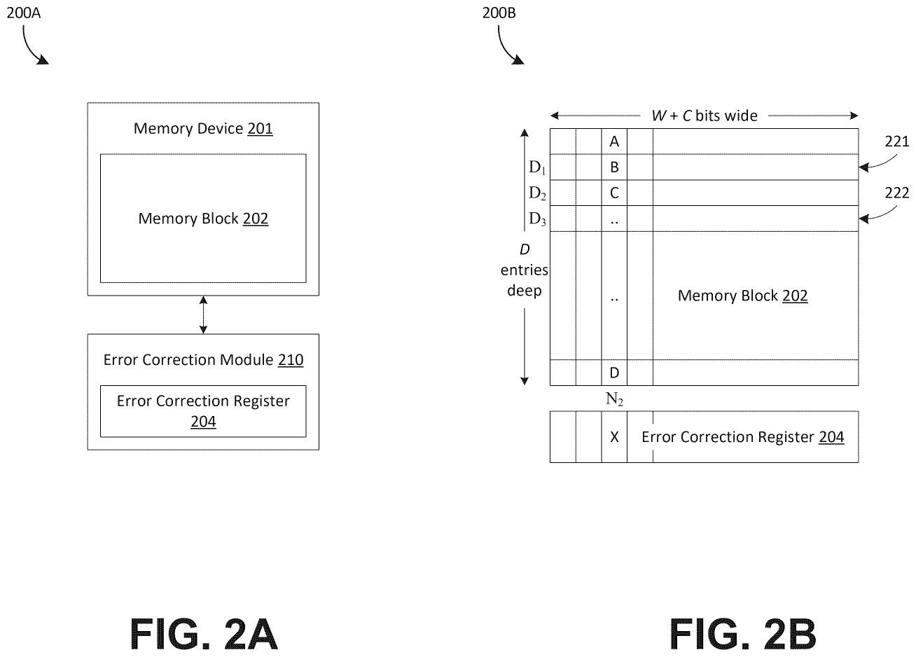

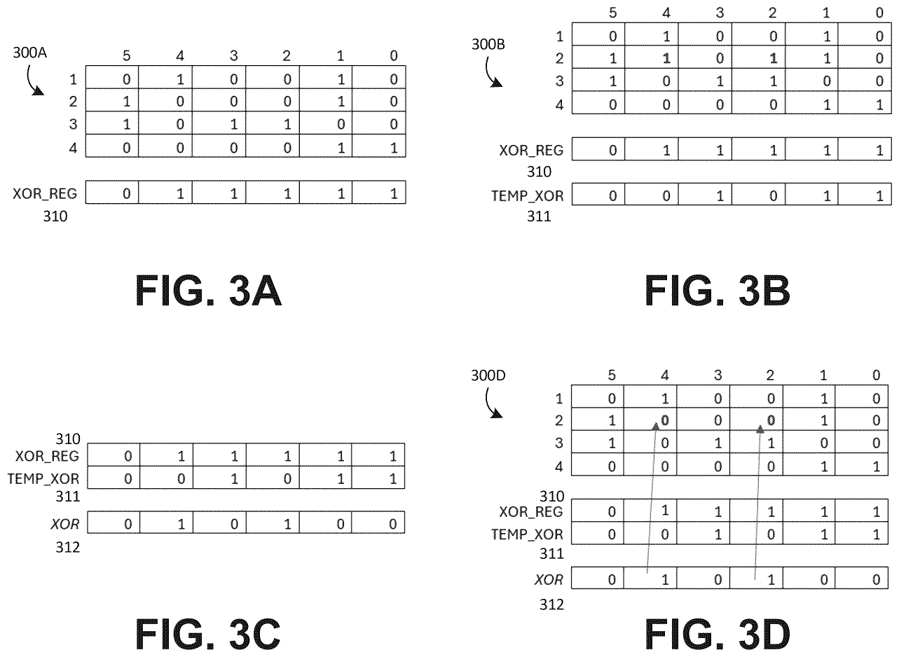

The client 101 can include a processing device 112, a memory device 114, and an error correction module 116. The client 102 can include a processing device 122, a memory device 124, and an error correction module 126. In some embodiments, a portion of the error correction module 116 can be included in the processing device 112, or in the memory device 114. The error correction module 116 (or error correction module 126) can perform one or more error correction operations on data stored at the memory device 114 (or memory device 124, respectively). The error correction module 116 can be a hardware, software, and/or firmware implementation that allows the client 101 to correct errors in data stored at the memory device 114. In some embodiments, the error correction module 116 can perform one or more bit error corrections to correct errors that were not corrected by an error correction operation (e.g., un-correctable soft errors). Additional details regarding the correction of bit error(s) by the error correction module 116, 126 are described below with reference to FIGS. 2A-3D.

The device 110 can be an integrated circuit of a graphics processing unit (GPU), a switch (e.g., a high-speed network switch), a network adapter, a central processing unit (CPU), a data processing unit (DPU), a neural processing unit (NPU), an application-specific integrated circuit (ASIC), a field programmable gate array (FPGA), a network interface card (NIC), or the like. In some embodiments, the device 110 can be implemented as a component in the client 101, and the device 120 can be implemented as a component in the client 102.

The communication interconnect 100 allows the client 101 to communicate with the client 102 via the channel 104 and device 110 and device 120, respectively. The client 101 can cause the device 110 to transmit and receive data with the client 102 (or another client coupled to the channel 104 via another respective device) via the communication network 103. Similarly, the client 102 can cause the device 120 to transmit and receive data across the communication network 103.

Examples of the communication network 103 that may be used to connect the device 110 and device 120 include wires, conductive traces, bumps, terminals, optical fibers, or the like. In other embodiments, the communication network 103 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 103 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 103 is a network that enables data transmission between the device 110 and device 120 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the control logic 113, as described herein.

Other examples for the communication network 103 can include other chip-to-chip or die-to-die interconnects, such as GRS, LPI (low power interface) or LLI (low latency interface).

In embodiments, the device 110 can interface with the client 101 to transmit and receive data over a two-way communication stream (e.g., channel 104 of the communication network 103). The channel 104 can be PCIe, NVLink, Ethernet, InfiniBand, Ground Reference Signal (GRS), C2C, D2D, or the like. As illustrated, the device 110 includes a transceiver 111. In some embodiments, the device 110 can include a transmitter and a receiver (e.g., separate devices).

The transceiver 111 (and the transceiver 121) includes suitable software, firmware, and/or hardware for receiving digital data from a source (e.g., client 101) and outputting data signals for transmission via the communication network 103. In some embodiments, the transceiver 111 can generate and transmit a data signal from the client 101 to the device 120, via the communication network 103. For example, the transceiver 111 can generate and transmit a data signal across the channel 104 to the device 120. In some embodiments, the transceiver 111 can include a transmitter circuit. In some embodiments, the functionality of the transceiver 111 can be performed by one or more devices, such as a transmitter device including a transmitter circuit to perform the transmission functions of the transceiver 111 (and the transceiver 121).

The transceiver 111 (and the transceiver 121) includes suitable software, firmware, and/or hardware for receiving digital data from a device via the communication network 103 and outputting digital data for further processing by a recipient (e.g., client 101). For example, the transceiver 111 may include components for receiving processing signals to extract the data for storing in a memory. In some embodiments, the transceiver 111 can receive and process a data signal including data from the client 101 over the communication network 103 from another device 120. For example, the transceiver 121 can receive a data signal from the client 101 via the channel 104. In some embodiments, the transceiver 111 receives an incoming signal and samples the incoming signal to generate samples, such as using an analog-to-digital converter (ADC). In some embodiments, the transceiver 111 can include a receiver circuit. In some embodiments, the functionality of the transceiver 111 can be performed by one or more devices, such as a receiver device including a receiver circuit to perform the receiving functions of the transceiver 111 (and the transceiver 121).

In some embodiments, the transceiver 111 can include multiple processing elements, such as one or more of transaction layer logic, datalink layer logic, or physical layer logic. The transceiver 111 or selected elements of the device 110 may take the form of a pluggable card or respective controller for the device 110. For example, the transceiver 111 or selected elements of the device 110 may be implemented on a network interface card (NIC).

The device 110 can include control logic 113. Similarly, the device 120 can include control logic 123. The control logic 113 (or the control logic 123) can cause the device 110 to perform one or more functions, such as transmitting and receiving data signals over the communication network 103. In some embodiments, the control logic 113 causes the transceiver 111 of the device 110 to transmit a data signal over the communication network 103. In some embodiments, the control logic 113 causes the transceiver 111 of the device 110 to receive a data signal over the communication network 103.

The control logic 113 may comprise software, hardware, or a combination thereof. For example, the control logic 113 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally, or alternatively, the control logic 113 may comprise hardware, such as an Application-Specific Integrated circuit (ASIC). Other non-limiting examples of the control logic 113 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the control logic 113 may be provided on a Printed Circuit Board (PCB) or collection of PCBs. It should be appreciated that any appropriate type of electrical component or collection of electrical components may be suitable for inclusion in the control logic 113. The control logic 113 may send and/or receive signals to and/or from other elements of the device 110 to control the overall operation of the device 110.

FIG. 2A is an example block diagram 200A of a memory device 201 coupled to an error correction module 210, according to some aspects of the disclosure. In some embodiments, a portion of the error correction module 210 can be included in the memory device 201. In some embodiments, the memory device 201 can be the same as or similar to the memory device 114 or the memory device 124 of FIG. 1. In some embodiments, the error correction module 210 can be the same as or similar to the error correction module 116 or the error correction module 126 of FIG. 1.

The memory device 201 can include a memory block 202. The memory block can include memory locations to which data can be written, as is further illustrated below in FIG. 2B.

The error correction module 210 can include an error correction register 204. In some embodiments, the error correction module 210 can include additional error correction registers, such as a secondary or temporary error correction register. It can be appreciated that while a register is illustrated and described here, other storage devices are also considered. The error correction module 210 can cause the memory device 201 to perform one or more error correction operations. As used herein, an “error correction operation” is a process or function designed to identify and correct errors that occur in data transmission or storage. These errors can occur due to signal noise, hardware issues, or environmental factors, resulting in corrupted data. In some embodiments, the error correction operation can include using any form of redundant data to reconstruct corrupted data. Examples of error correction operations can include, for example, ECC, SEC-DED, forward error correction (FEC), automatic repeat request (ARQ), parity checks, checksums, Reed-Solomon codes, Hamming codes, or the like.

FIG. 2B is an example table 200B of entries in the memory block 202, according to some aspects of the disclosure. The memory block 202 includes D number of entries. Each entry has N number of bits. N number of bits includes W number of data bits, and C number of code bits (i.e., W+C=N). In some embodiments, the number of code bits C is determined based on an error correction operation that is used by the error correction module 210 of FIG. 2A. When the data bits W are to be written to the memory block 202, the error correction module 210 (or other component of the memory device 201) can determine the values of code bits C that will be written with the data bits W. In some embodiments, the code bits can include, for example, checksums or parity bits.

Each entry D has bit positions N₀-N_{N}. The error correction register 204 is configured to store N number of bits. In some embodiments (not illustrated), the error correction register 204 is configured to store W number of bits. The error correction register 204 has one entry with bit positions N₀-N_{N}. The error correction register 204 stores cumulative error data for the memory block 202. The error correction module 210 can determine and store the cumulative error data in the error correction register 204. In some embodiments, the cumulative error data is determined by bit position, or as illustrated, by column. An XOR operation is performed for each bit position N_{N} of each data entry D. The result of the XOR operation for a bit position N_{N} is stored in the corresponding bit position N_{N} of the error correction register 204. In an illustrative example, an XOR operation is performed on bits in the N₂ bit position of each entry D in the memory block 202, (e.g., A⊕B⊕C⊕ . . . ⊕D). The resulting value X is stored at the N₂ bit position of the error correction register 204. In this way, the cumulative error data can be determined and stored in the error correction register 204. In some embodiments, this is how the current cumulative error data can be determined. In some embodiments, when data is written to an entry D_{D}, an XOR operation can be performed on the data written to the entry D_{D} and the cumulative error data stored at the error correction register 204 when the data is written to the memory block 202. In an illustrative example, when data is written to the entry D₁, an XOR operation is performed on each bit of the data (e.g., at N₀, N₁, . . . N_{N}, etc.) with each corresponding bit of the error correction register 204, (e.g., B⊕X at bit position N₂). In some embodiments, the result of the XOR operation can be stored in a secondary or temporary register (not illustrated). When the XOR operation has been completed, the values of the secondary register can be used to overwrite the values of the error correction register 204, and the secondary register can be reset. In alternative embodiments, once the XOR operation has been completed and the cumulative error data is stored in the secondary register, the error correction register 204 can be reset.

In some embodiments, a first-in-first-out (FIFO) memory solution may be implemented with the memory block 202. A read pointer 221 can point to entry D₁, and a write pointer 222 can point to entry D₃, meaning that the FIFO has 2 valid entries (e.g., D₁ and D₂). Thus, the cumulative error data stored in the error correction register 204 can be determined based on the entries D₁, D₂, and D₃, discarding all other entries in the memory block 202. It can be appreciated that while a FIFO is described, any sub-section of the memory block 202 can be used similarly to perform error correction of un-correctable soft errors. In some embodiments, a single code bit C is used (e.g., a parity bit). In such embodiments, the cumulative error data would also be a single bit, and could be similarly used to detect and correct soft errors in the memory block 202, as described above.

FIG. 3A illustrates an example memory block entry table 300A and corresponding XOR register 310, according to some aspects of the disclosure.

The memory block table 300A has data entries 1, 2, 3, and 4, (e.g., 010010, 10010, 101100, 000011, respectively) written to bit positions 5, 4, 3, 2, 1, and 0. An XOR operation on the data entries yields the value 011111, which is stored at the XOR register 310.

In FIG. 3B, due to external interference, the bits stored at (2, 4), and (2, 2) flip (e.g., change from “0” to “1” in the illustrative example), resulting in a soft error in the data entry 2 of the memory block entry table 300B. A current cumulative error value is determined after the bit flip has occurred, such as when a read of data from the memory block is requested. In some embodiments, and as illustrated, the current cumulative error value can be stored in a secondary register, such as temporary register 311. The current cumulative error value can be determined as described above with reference to FIG. 2 and FIG. 3A.

In FIG. 3C, an XOR operation is performed on the values stored in the XOR register 310 and the temporary register 311, resulting in the XOR bit flip data 312. Each “1” in the the XOR bit flip indicates a bit position N where a bit flip has occurred in the memory block. As illustrated, the XOR register 310 and temporary register 311 can be separate registers. In alternative embodiments, the XOR register 310 and the temporary register 311 can represent XOR values that are determined based on the XOR operations performed at each bit position N of the memory block. Similarly, the XOR bit flip data 312 may be stored in a separate register, or in memory.

In FIG. 3D, the memory block entry table 300D shows the values in the memory block after a bit flip operation has been performed to correct the bit flip that occurred from external interference (as illustrated in FIG. 3B). Once the bit error correction has been completed, the memory block can resume normal operation.

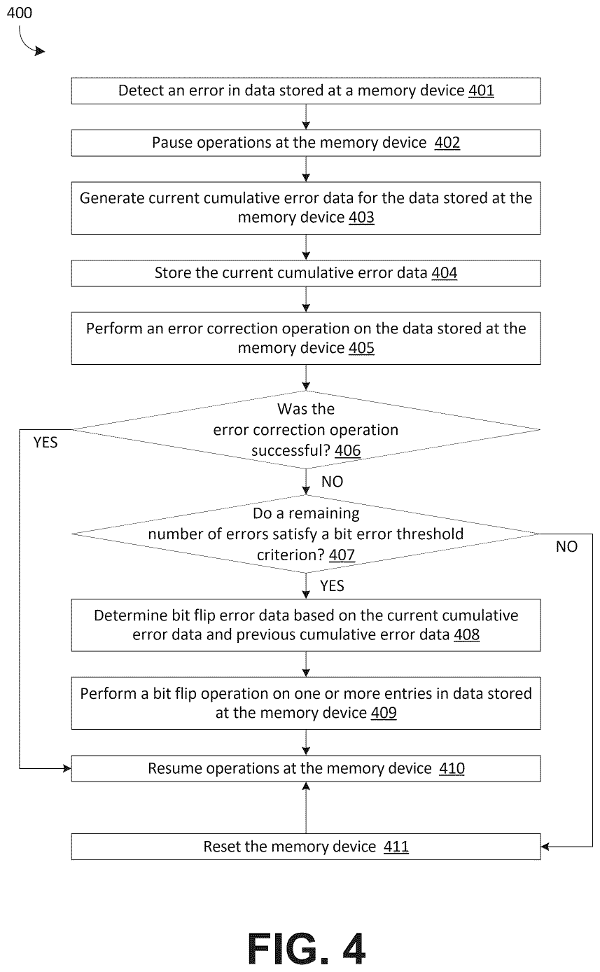

FIG. 4 is a flow diagram of an example method 400 for correcting errors in a memory device, according to aspects of the disclosure. The method 400 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the control logic 113 or the error correction module 116 of FIG. 1. It can be appreciated that the control logic can refer to, or include hardware or an electrical circuit (e.g., hardware logic) that is configured such that the hardware performs the steps of the control logic as an electrical circuit passes through each hardware component of the electrical circuit. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 401, control logic performing the method 400 detects an error in data stored at a memory device. In some embodiments, the error detection can occur as a precursor to performing a memory operation, such as a read operation on a memory block of the memory device.

At operation 402, the control logic pauses operations at the memory device. In some embodiments, the operations are paused using an interrupt. In some embodiments, the control logic pauses operations at a portion of the memory device (i.e., an affected block of the memory device).

At operation 403, the control logic generates current cumulative error data for the data stored at the memory device. The current cumulative error data can be determined based on the values stored at each entry of the memory block. In some embodiments, as described above, an XOR operation can be performed on all entries in the memory block.

At operation 404, the control logic stores the current cumulative error data. In some embodiments, the current cumulative error data can be stored in a designated error data register. That is, the hardware components of the error correction module 116 can include a physical register that is designated to store the current cumulative error data. In some embodiments, the current cumulative error data is stored in another location in memory, such as a protected location of the affected memory block, or another memory block of the memory device.

At operation 405, the control logic performs an error correction operation on the data stored at the memory device. Error correction operations can include ECC, SEC-DED, or the like. This error operation is performed on the data bits of an entry using the code bits of the same entry, as is described above with reference to FIG. 2. In some embodiments, the error correction operation can include the operation 401, which detects an error in data stored at the memory device. In some embodiments, the error correction operation can correct the errors that were detected at the memory device (e.g., see operation 406 and 410, below). In alternative embodiments, the error correction operation is unable to correct all of the errors that were detected at the memory device (e.g., see operation 406-411, below).

At operation 406, the control logic determines whether the error correction operation was successful. That is, the control logic determines whether errors are still present in the data stored at the memory device. If the error correction operation was successful, the control logic proceeds to the operation 410, and resumes operations at the memory device. If the error correction operation was not successful, the control logic proceeds to the operation 407.

At operation 407, responsive to determining the error correction was not successful, the control logic determines whether a remaining number of errors satisfy a bit error threshold criterion. The bit error threshold criterion can be based on a number of bit errors (e.g., bit flips) in a given bit position of the memory block. In some embodiments, the bit error threshold criterion is based on a number of entries in the memory block that have a bit error. For example, if the bit error threshold criterion is 1, and the memory block includes 2 entries with errors, then the bit error threshold criterion has been exceeded. In alternative embodiments, the bit error threshold criterion is based on a number of bit errors in bit positions of entries in the memory block. For example, if the bit error threshold criterion is 1, and the memory block includes 2 entries with errors, but each error is at a different bit position, then the bit error threshold criterion has not been exceeded. If the remaining number of errors exceeds the bit error threshold criterion (e.g., does not satisfy the bit error threshold criterion), the control logic proceeds to the operation 411 and resets the memory device. If the remaining number of errors does not exceed the bit error threshold criterion (e.g., satisfies the bit error threshold criterion), the control logic proceeds to the operation 408.

At operation 408, the control logic determines bit flip error data based on the current cumulative error data and previous cumulative error data. In some embodiments, the bit flip error data is determined by performing an XOR operation on the current cumulative error data and the previous cumulative error data, such as is described above with reference to FIG. 3C.

At operation 409, the control logic performs a bit flip operation on one or more entries in data stored at the memory device. The bit flip operation can be used to change the values of one or more bits in a data entry in a memory block. The bits that are flipped are identified by the cumulative error data. In some embodiments, the current cumulative error data and the previous cumulative error data can be used to determine the bit positions of bits that are to be flipped. When a bit is flipped, a “0” is changed to a “1,” or a “1” is changed to a “0.” In some embodiments, the bit flip operation is performed if the soft errors in the memory block are contained in a single entry. In some embodiments, the bit flip operation can be performed if the soft errors in the memory block do not occur at the same bit position. For example, if a first entry has a soft error at a second bit position of the first entry, and a second entry has a soft error at a third bit position of the second entry, since the soft errors at the two entries are at different bit positions, the bit flip operation can be performed (e.g., as determined above with reference to the operation 407).

At operation 410 the control logic causes operations of the memory device to resume. Operation 410 may be performed in response to satisfying the condition at the operation 406, after performing the operation 409, or after performing the operation 411.

At operation 411, responsive to determining that a remaining number of errors do not satisfy the bit error threshold criterion (e.g., failing the operation 407), the control logic resets the memory device. In some embodiments, instead of resetting the memory device, the control logic sends a message to a controller of the client indicating that the memory block contains too many errors, and requests what operation should be performed. The controller of the client can transmit instructions to proceed, such as instructions to perform a reset operation at the memory device, or to rewrite a portion of the memory block, or the like. After the memory device is reset, the control logic can proceed to the operation 410, where the control logic causes operations to resume at the memory device.

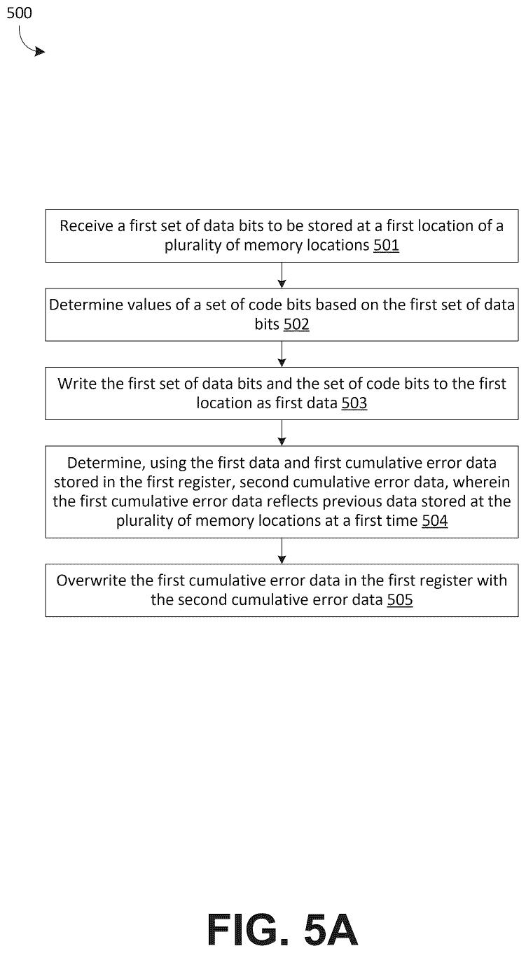

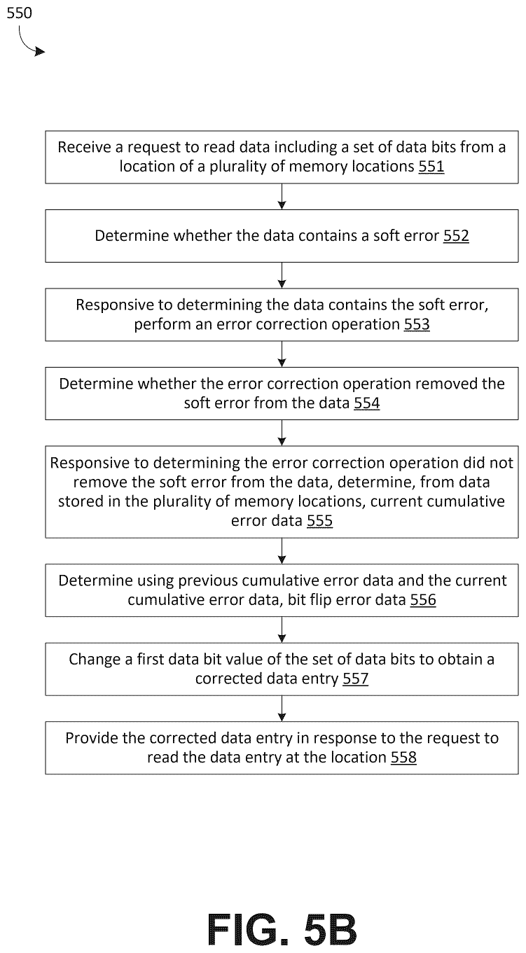

FIG. 5A is a flow diagram of an example method 500 for correcting errors in a memory device, according to aspects of the disclosure. The method 500 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the control logic 113 or the error correction module 116 of FIG. 1. It can be appreciated that the control logic can refer to, or include hardware or an electrical circuit (e.g., hardware logic) that is configured such that the hardware performs the steps of the control logic as an electrical circuit passes through each hardware component of the electrical circuit. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the control logic performing the method 500 receives a first set of data bits to be stored at a first location of a plurality of memory locations in a memory device.

At operation 502, the control logic determines values of a set of code bits based on the first set of data bits.

At operation 503, the control logic writes the first set of data bits and the set of code bits to the first location as first data.

At operation 504, the control logic determines, using the first data and first cumulative error data stored in a first data associated with the memory device, second cumulative error data. The first cumulative error data reflects previous data stored at the plurality of memory locations at a first time. That is, the first cumulative error data can be generated from previous entries in the memory block of the memory device. In some embodiments, to determine the second cumulative error data, the control logic performs a first bitwise exclusive-or (XOR) operation using (i) the first data, and (ii) the first cumulative error data.

At operation 505, the control logic overwrites the first cumulative error data in the first register with the second cumulative error data. In some embodiments, the memory device can include a second register. The control logic can write the second cumulative error data to the second register. In an alternative embodiment, the control logic writes the second cumulative error data to the second register and resets the first register to the default state (e.g., all “0s” or all “1s”).

FIG. 5B is a flow diagram of an example method 550 for correcting errors in a memory device, according to aspects of the disclosure. The method 550 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 550 is performed by the control logic 113 or the error correction module 116 of FIG. 1. It can be appreciated that the control logic can refer to, or include hardware or an electrical circuit (e.g., hardware logic) that is configured such that the hardware performs the steps of the control logic as an electrical circuit passes through each hardware component of the electrical circuit. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. In some embodiments, the method 550 is performed with the method 500 of FIG. 5A.

At operation 551, the control logic performing the method 550 receives a request to read a data entry from a location of a plurality of memory locations. The data entry at the location can include a set of data bits.

At operation 552, the control logic determines whether the data contains a soft error.

At operation 553, responsive to determining the data contains the soft error, the control logic performs an error correction operation. The error correction operation can include one or more of a ECC or SEC-DED error correction operation. In some embodiments, the control logic can determine that a detected error is not resolvable by an error correction operation. In such embodiments, the control logic can refrain from performing an error correction operation and proceed to the operation 556.

At operation 554, the control logic determines whether the error correction operation removed the soft error from the data. In some embodiments, the control logic determines whether the data from the error correction operation satisfies a bit error criterion. The bit error criterion can be a criterion for each bit position of data entries in a memory block (e.g., a set of data bits corresponds to multiple bit positions). That is, the bit error criterion can be a maximum number of bit flip errors for a given bit flip position across a set of entries in the memory block. For example, if the bit flip criterion is 1, and a first entry has a bit flip error at bit position 1 and a second entry has a bit flip error at bit position 2, then the entries collectively satisfy the bit flip criterion (e.g., the number of bit flips in the memory block for a given bit position do not exceed 1). In another example, if the bit flip criterion is 1, and a first entry has a bit flip error at bit position 1 and a second entry has a bit flip error at bit position 1, then the entries collectively do not satisfy the bit flip criterion (e.g., the number of bit flips in the memory block for the bit position 1 exceed 1). In some embodiments, the control logic can determine that the entries in the memory block do not satisfy the bit error criterion. In some embodiments, the control logic can determine, for each data entry in a memory block a respective number of bit errors in the data entry, and respective bit positions of each bit error.

In such embodiments, the control logic can reset the memory block to a default state and exit the method 550 (e.g., the control logic can perform a reset operation at the memory block).

At operation 555, responsive to determining that the error correction operation did not remove the soft error from the data, the control logic determines, from data stored in the plurality of memory locations, current cumulative error data. The data stored in the plurality of memory locations can refer to all data stored at all locations.

At operation 556, the control logic determines, using previous cumulative error data and the current cumulative error data, bit flip error data. In some embodiments, the control logic determines the bit flip error data by performing a bitwise XOR operation using (i) the previous cumulative error data (e.g., second cumulative error data), and (ii) the current cumulative error data (e.g., third cumulative error data).

At operation 557, the control logic changes a first data bit value of the set of data bits (e.g., of the data entry) to obtain a corrected data entry. The control logic changes a bit value from “0” to “1” or from “1” to “0,” based on an indication of a bit flip at a given bit position in the bit flip data.

At operation 558, the control logic provides the corrected data entry in response to the request to read the data entry. In some embodiments, the control logic can perform a verification operation to determine whether the bit flip operation was successful.

### COMPUTER SYSTEMS

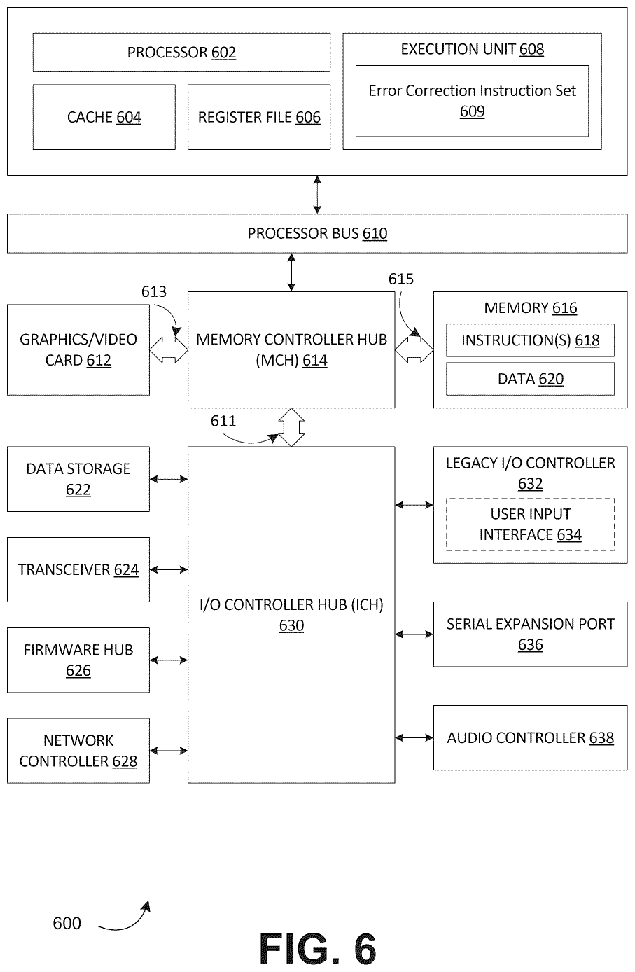

FIG. 6 is a block diagram illustrating an exemplary computer system, such as computer system 600, which can be a system with interconnected devices and components, a system-on-a-chip (SOC), or some combination thereof, according to aspects of the disclosure. In some embodiments, computer system 600 can include, without limitation, a component, such as a processor 602, to employ execution units including logic to perform algorithms for process data, in accordance with the present disclosure, such as in the embodiments described herein. In some embodiments, computer system 600 can include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In some embodiments, computer system 600 can execute a version of WINDOWS' operating system available from Microsoft Corporation of Redmond, Wash., although other operating systems (UNIX and Linux, for example), embedded software, and/or graphical user interfaces, can also be used.

Embodiments can be used in other devices such as handheld devices and embedded applications. Some examples of handheld devices include cellular phones, Internet Protocol devices, digital cameras, personal digital assistants (PDAs), and handheld PCs. In some embodiments, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one embodiment.

In some embodiments, computer system 600 can include, without limitation, processor 602 that can include, without limitation, one or more execution units 608 to perform operations according to techniques described herein. In some embodiments, computer system 600 is a single-processor desktop or server system, but in another embodiment, the computer system 600 can be a multiprocessor system. In some embodiments, processor 602 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In some embodiments, processor 602 can be coupled to a processor bus 610 that can transmit data signals between processor 602 and other components in computer system 600.

In some embodiments, processor 602 can include, without limitation, a Level-1 (L1) internal cache memory (cache) cache 604. In some embodiments, processor 602 can have a single internal cache or multiple levels of internal cache. In some embodiments, the cache memory can reside external to processor 602. Other embodiments can also include a combination of both internal and external caches depending on particular implementation and needs. In some embodiments, register file 606 can store different types of data in various registers, including and without limitation, integer registers, floating-point registers, status registers, and instruction pointer registers.

In some embodiments, an execution unit 608, including and without limitation, logic to perform integer and floating-point operations, also reside in processor 602. In some embodiments, processor 602 can also include a microcode (μcode) read-only memory (ROM) that stores microcode for certain macro instructions. In some embodiments, execution unit 608 can include logic to handle an error correction instruction set 609. In some embodiments, by including error correction instruction set 609 in an instruction set of a general-purpose processor, such as processor 602, along with associated circuitry to execute instructions, operations used by many multimedia applications can be performed using packed data in a general-purpose processor, such as processor 602. In one or more embodiments, many multimedia applications can be accelerated and executed more efficiently by using the full width of a processor's data bus for performing operations on packed data, which can eliminate the need to transfer smaller units of data across the processor's data bus to perform one or more operations one data element at a time.

In some embodiments, execution unit 608 can also be used in microcontrollers, embedded processors, graphics devices, DSPs, and other types of logic circuits. In some embodiments, computer system 600 can include, without limitation, a memory 616. In some embodiments, memory 616 can be implemented as a Dynamic Random Access Memory (DRAM) device, a Static Random Access Memory (SRAM) device, a flash memory device, or other memory devices. In some embodiments, memory 616 can store instruction(s) 618 and/or data 620 represented by data signals that can be executed by processor 602.

In some embodiments, the system logic chip can be coupled to processor bus 610 and memory 616. In some embodiments, the system logic chip can include, without limitation, a memory controller hub (MCH), such as MCH 614, and processor 602 can communicate with MCH 614 via processor bus 610. In some embodiments, MCH 614 can provide a high bandwidth memory path 615 to memory 616 for instruction and data storage and for storage of graphics commands, data, and textures. In some embodiments, MCH 614 can direct data signals between processor 602, memory 616, and other components in computer system 600 and bridge data signals between processor bus 610, memory 616, and a system input/output (I/O) 611. In some embodiments, a system logic chip can provide a graphics port for coupling to a graphics controller. In some embodiments, MCH 614 can be coupled to memory 616 through a high bandwidth memory path 615, and graphics/video card 612 can be coupled to MCH 614 through an Accelerated Graphics Port (AGP) interconnect 613.

In some embodiments, computer system 600 can use the system I/O 611 that is a proprietary hub interface bus to couple the MCH 614 to I/O controller hub (ICH), such as ICH 630. In some embodiments, ICH 630 can provide direct connections to some I/O devices via a local I/O bus. In some embodiments, a local I/O bus can include, without limitation, a high-speed I/O bus for connecting peripherals to memory 616, chipset, and processor 602. Examples can include, without limitation, data storage 622, a transceiver 624, a firmware hub (flash Basic Input/Output System (BIOS)) 626, a network controller 628, a legacy I/O controller 632 containing a user input interface 634, a serial expansion port 636, such as Universal Serial Bus (USB), and an audio controller 638. In some embodiments, data storage 622 can include a hard disk drive, a floppy disk drive, a compact disc read-only memory (CD-ROM) device, a flash memory device, or other mass storage devices.

In some embodiments, FIG. 6 illustrates a computer system 600, which includes interconnected hardware devices or “chips,” whereas, in other embodiments, FIG. 6 can illustrate an exemplary System on a Chip (SoC). In some embodiments, devices can be interconnected with proprietary interconnects, standardized interconnects (e.g., Peripheral Component Interconnect buses (e.g., PCI, PCI Express)), or some combination thereof. In some embodiments, one or more components of computer system 600 are interconnected using compute express link (CXL) interconnects.

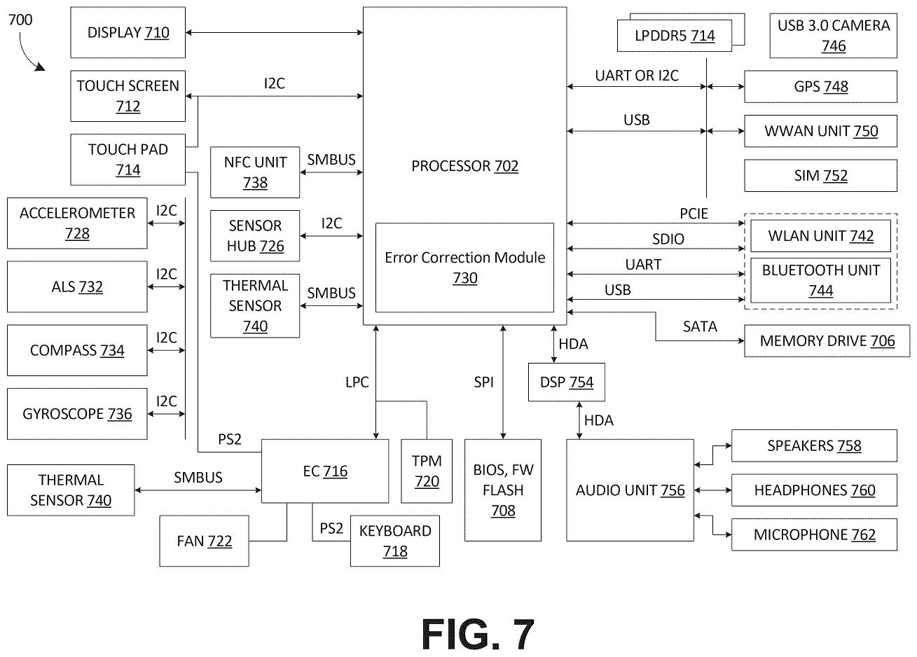

FIG. 7 Is a block diagram illustrating an electronic device 700 for utilizing a processor 702, according to aspects of the disclosure. In some embodiments, electronic device 700 can be, for example, and without limitation, a notebook, a tower server, a rack server, a blade server, a laptop, a desktop, a tablet, a mobile device, a phone, an embedded computer, or any other suitable electronic device.

In some embodiments, electronic device 700 can include, without limitation, processor 702 communicatively coupled to any suitable number or kind of components, peripherals, modules, or devices. In some embodiments, processor 702 coupled using a bus or interface, such as an Inter-Integrated Circuit (I2C) bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen 1/3.1 Gen2, and USB4), or a Universal Asynchronous Receiver/Transmitter (UART) bus. In some embodiments, FIG. 7 illustrates a system, which includes interconnected hardware devices or “chips,” whereas in other embodiments, FIG. 7 can illustrate an exemplary System on a Chip (SoC). In some embodiments, devices illustrated in FIG. 7 can be interconnected with proprietary interconnects, standardized interconnects (e.g., PCIe), or some combination thereof. In some embodiments, one or more components of FIG. 7 are interconnected using compute express link (CXL) interconnects.

In some embodiments, FIG. 7 can include a display 710, a touch screen 712, a touch pad 714, a Near Field Communications unit (NFC) 738, a sensor hub 726, a thermal sensor 740, an Express Chipset (EC), such as EC 716, a Trusted Platform Module (TPM), such as TPM 720, BIOS/firmware(FW)/flash memory, such as BIOS, FW Flash 708, a DSP 754, a memory drive 706 such as a Solid State Disk (SSD) or a Hard Disk Drive (HDD), a wireless local area network unit (WLAN), such as WLAN unit 742, a Bluetooth unit 744, a Wireless Wide Area Network unit (WWAN), such as WWAN unit 750, a Global Positioning System (GPS) 748, a camera (USB 3.0 camera) 746, such as a USB 3.0 camera, and/or a Low Network bandwidth Double Data Rate (LPDDR) memory unit, such as LPDDR 5 704 implemented in, for example, LPDDR5 standard. These components can each be implemented in any suitable manner.

In some embodiments, other components can be communicatively coupled to processor 702 through the components discussed above. In some embodiments, processor 702 can include an error correction module 730. In some embodiments, an accelerometer 728, Ambient Light Sensor (ALS), such as ALS 732, compass 734, and a gyroscope 736 can be communicatively coupled to sensor hub 726. In some embodiments, thermal sensor 740, a fan 722, a keyboard 718, and a touch pad 714 can be communicatively coupled to EC 716. In some embodiments, speakers 758, headphones 760, and microphone 762 can be communicatively coupled to an audio unit 756 which can, in turn, be communicatively coupled to DSP 754. In some embodiments, audio unit 756 can include, for example, and without limitation, an audio coder/decoder (codec) and a class-D amplifier. In some embodiments, a subscriber identification module (SIM) card, such as SIM 752 can be communicatively coupled to WWAN unit 750. In some embodiments, components such as WLAN unit 742 and Bluetooth unit 744, as well as WWAN unit 750 can be implemented in a Next Generation Form Factor (NGFF).

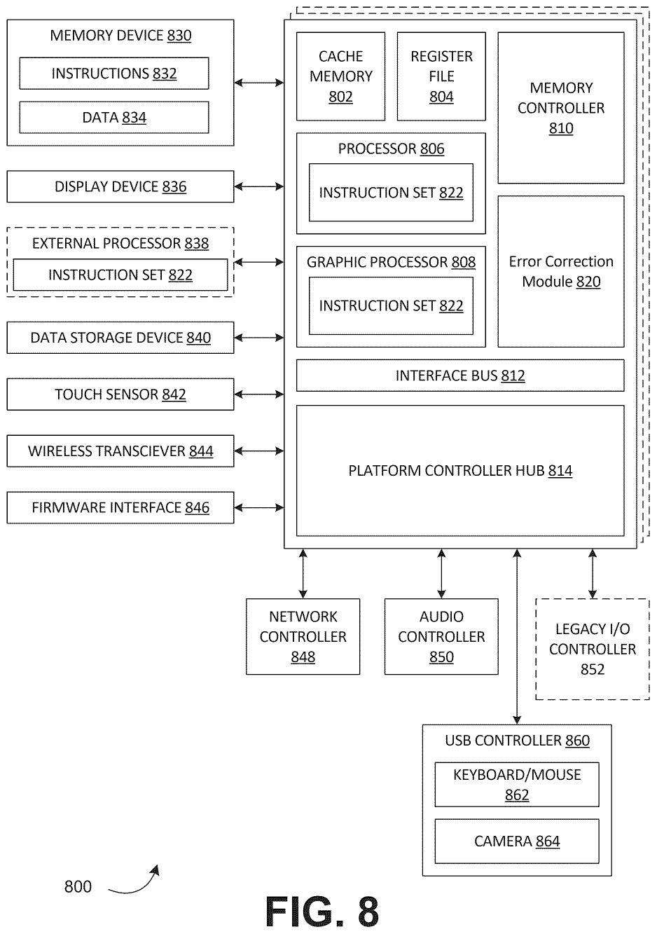

FIG. 8 is a block diagram of a processing system 800, according to aspects of the disclosure. In some embodiments, the processing system 800 includes cache memory 802, register file 804, processors 806, graphics processors 808, memory controller 810, interface bus 812, platform controller hub 814, and error correction module 820. Processing system 800 can be a single processor desktop system, a multiprocessor workstation system, or a server system having a large number of processors 806 or graphics processors 808. In some embodiments, the processing system 800 is a processing platform incorporated within a system-on-a-chip (SoC) integrated circuit for use in mobile, handheld, or embedded devices.

In some embodiments, the processing system 800 can include, or be incorporated within a server-based gaming platform, a game console, including a game and media console, a mobile gaming console, a handheld game console, or an online game console. In some embodiments, the processing system 800 is a mobile phone, smart phone, tablet computing device, or mobile Internet device. In some embodiments, the processing system 800 can also include, couple with, or be integrated within, a wearable device, such as a smart watch wearable device, smart eyewear device, augmented reality device, or virtual reality device. In some embodiments, the processing system 800 is a television or set-top box device having one or more processors 806 and a graphical interface generated by one or more graphics processors 808.

In some embodiments, one or more processors 806 each include one or more of the processor cores to process instructions which, when executed, perform operations for system and user software. In some embodiments, one or more processors 806 and/or one or more graphics processors can be configured to process the instruction set 822. In some embodiments, instruction set 822 can facilitate Complex Instruction Set Computing (CISC), Reduced Instruction Set Computing (RISC), or computing via a Very Long Instruction Word (VLIW). In some embodiments, processor cores can each process a different instruction set from instruction set 822, which can include instructions to facilitate emulation of other instruction sets (not illustrated). In some embodiments, processor cores can also include other processing devices, such as a Digital Signal Processor (DSP).

In some embodiments, processors 806 includes cache memory 802. In some embodiments, processors 806 can have a single internal cache or multiple levels of internal cache. In some embodiments, cache memory 802 is shared among various components of processors 806. In some embodiments, processors 806 also uses an external cache (e.g., a Level-3 (L3) cache or Last Level Cache (LLC)) (not illustrated), which can be shared among processor cores using known cache coherency techniques. In some embodiments, register file 804 is additionally included in processors 806, which can include different types of registers for storing different types of data (e.g., integer registers, floating-point registers, status registers, and an instruction pointer register). In some embodiments, register file 804 can include general-purpose registers or other registers.

In some embodiments, one or more processors 806 are coupled with one or more interface bus 812 to transmit communication signals such as address, data, or control signals between processor cores and other components in processing system 800. In some embodiments, interface bus 812, in one embodiment, can be a processor bus, such as a version of a Direct Media Interface (DMI) bus. In some embodiments, interface bus 812 is not limited to a DMI bus, and can include one or more PCI buses (e.g., PCI, PCI Express), memory busses, or other types of interface busses. In some embodiments, processors 806 include an integrated memory controller (e.g., memory controller 810) and a platform controller hub 814 (PCH). In some embodiments, memory controller 810 facilitates communication between a memory device and other components of the processing system 800, while platform controller hub 814 provides connections to I/O devices via a local I/O bus.

In some embodiments, the memory device 830 can be a dynamic random-access memory (DRAM) device, a static random-access memory (SRAM) device, a flash memory device, a phase-change memory device, or some other memory device having suitable performance to serve as process memory. In some embodiments, the memory device 830 can operate as system memory for processing system 800 to store instructions 832 and data 834 for use when one or more processors 806 executes an application or process. In some embodiments, memory controller 810 also optionally couples with an external processor 838, which can communicate with one or more graphics processors 808 in processors 806 to perform graphics and media operations. In some embodiments, a display device 836 can connect to processors 806. In some embodiments, the display device 836 can include one or more of an internal display device, as in a mobile electronic device or a laptop device, or an external display device attached via a display interface (e.g., DisplayPort, etc.). In some embodiments, display device 836 can include a head-mounted display (HMD) such as a stereoscopic display device for use in virtual reality (VR) applications or augmented reality (AR) applications.

In some embodiments, the platform controller hub 814 enables peripherals to connect to memory device 830 and processors 806 via a high-speed I/O bus. In some embodiments, I/O peripherals include, but are not limited to, a data storage device 840 (e.g., hard disk drive, flash memory, etc.), a touch sensor 842, a wireless transceiver 844, firmware interface 846, a network controller 848, or an audio controller 850.

In some embodiments, the data storage device 840 can connect via a storage interface (e.g., SATA) or via a peripheral bus, such as a PCI bus (e.g., PCI, PCI Express). In some embodiments, touch sensor 842 can include touch screen sensors, pressure sensors, or fingerprint sensors. In some embodiments, wireless transceiver 844 can be a Wi-Fi transceiver, a Bluetooth transceiver, or a mobile network transceiver such as a 3G, 4G, Long Term Evolution (LTE), 5G, or 6G transceiver. In some embodiments, firmware interface 846 enables communication with system firmware and can be, for example, a unified extensible firmware interface (UEFI). In some embodiments, the network controller 848 can enable a network connection to a wired network. In some embodiments, a high-performance network controller (not illustrated) couples with interface bus 812. In some embodiments, audio controller 850 can be a multi-channel high-definition audio controller. In some embodiments, the processing system 800 includes an optional legacy I/O controller 852 for coupling legacy (e.g., Personal System-2 (PS/2)) devices to the processing system 800. In some embodiments, the platform controller hub 814 can also connect to one or more Universal Serial Bus (USB) controllers, such as USB controller 860 to connect input devices, such as a keyboard and mouse combination (keyboard/mouse 862), a camera 864, or other USB input devices.

In some embodiments, an instance of memory controller 810 and platform controller hub 814 can be integrated into a discreet external graphics processor, such as external processor 838. In some embodiments, the platform controller hub 814 and/or memory controller 810 can be external to one or more processors 806. For example, in some embodiments, the processing system 800 can include an external memory controller (e.g., memory controller 810) and the platform controller hub 814, which can be configured as a memory controller hub and peripheral controller hub within a system chipset that is in communication with the processors 806.

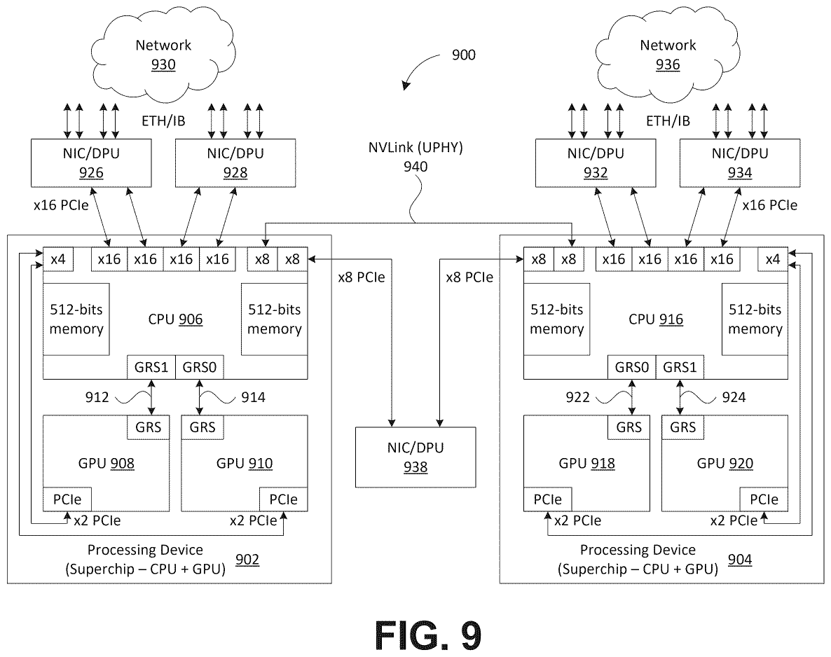

FIG. 9 is a block diagram of a computing system 900 having two processing devices coupled to each other and multiple networks according to some aspects of the disclosure. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900.

The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects.

The computing system 900 includes various types of interconnects. Each of the interconnects includes the transceivers or receivers that include, or be coupled to the control logic 113 and/or an error correction module 116 of FIG. 1, as described herein (not illustrated). In some embodiments, the computing system 1000 includes memory devices that can perform the bit error correction methods described herein with reference to FIG. 4 and FIG. 5.

In at least one embodiment, the computing system 900 is used for high-speed network communication and includes a processing unit (e.g., CPU 906, GPU 908, GPU 908, CPU 916, GPU 918, GPU 920, NIC/DPU 926, NIC/DPU 928, NIC/DPU 932, NIC/DPU 934, or NIC/DPU 938), and a network interface coupled to the processing unit. The network interface includes a memory device, such as memory device 114 of FIG. 1, and a controller, such as error correction module 116, operatively coupled to the memory device. The controller can cause the memory device to perform error correction operations (including the bit error correction operations described herein) on data stored in the memory device. Data may be stored to the memory device during data transmission (e.g., as part of a transmitter circuit). Data may also be stored to the memory device during data reception (e.g., as part of a receiver circuit). In some embodiments, controller causes the error correction operations to be performed when the data is stored to the memory device, and/or when the data is accessed from the memory device.

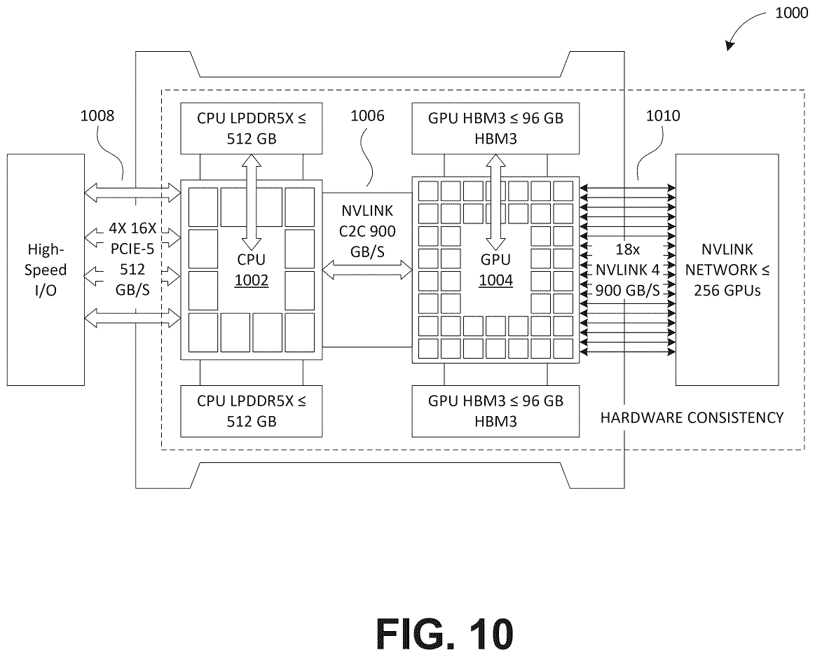

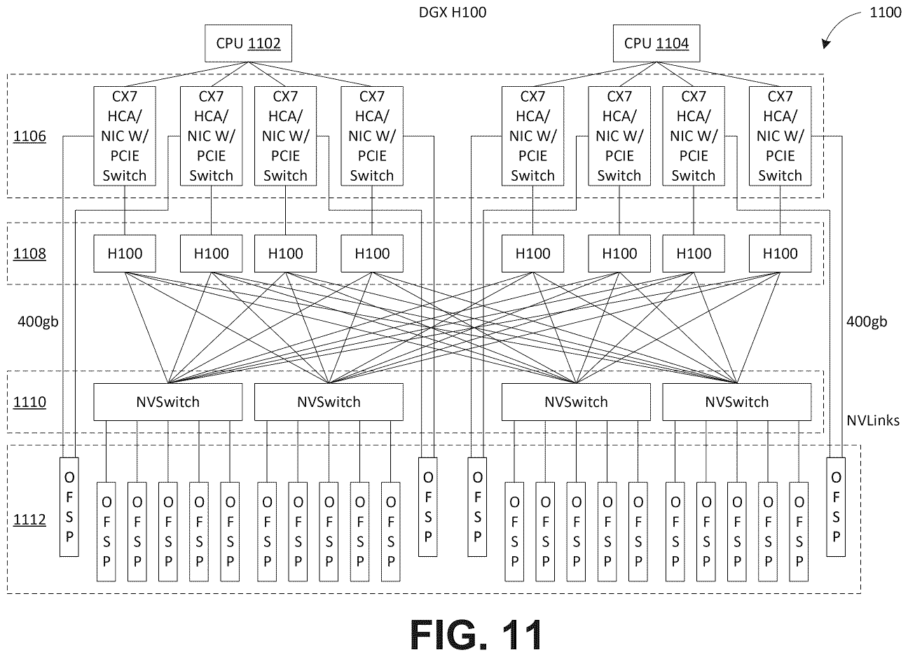

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability to include multiple GPU elements (e.g., up to 256 as illustrated), creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

The computing system 1000 includes various types of interconnects. Each of the interconnects includes the transceivers or receivers that include, or be coupled to the control logic 113 and/or an error correction module 116 of FIG. 1, as described herein (not illustrated). In some embodiments, the computing system 1000 includes memory devices that can perform the bit error correction methods described herein with reference to FIG. 4 and FIG. 5.

In at least one embodiment, the computing system 1000 is used for high-speed network communication and includes a processing unit (e.g., CPU 1002, GPU 1004, NVLink network), and a network interface coupled to the processing unit. The network interface can include the controller and memory device as described above with respect to FIG. 9.

FIG. 11 is a block diagram of a computing system 1100 having tensor core GPUs 1108 according to at least one embodiment. The computing system 1100 can be an NVIDIA© DGX H100 system which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 12. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The computing system 1100 includes various types of interconnects. Each of the interconnects includes the transceivers or receivers that include, or be coupled to the control logic 113 and/or an error correction module 116 of FIG. 1, as described herein (not illustrated). In some embodiments, the computing system 1000 includes memory devices that can perform the bit error correction methods described herein with reference to FIG. 4 and FIG. 5.

In at least one embodiment, the computing system 1100 is used for high-speed network communication and includes a processing unit (e.g., CPU 1102, CPU 1102, switches 1106, tensor core GPUs 1108, switches 1110, high-speed transceiver modules 1112), and a network interface coupled to the processing unit. The network interface can include the controller and memory device as described above with respect to FIG. 9.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors-for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A memory device comprising:
a plurality of memory locations;
a first register; and
hardware logic coupled to the plurality of memory locations and the first register, wherein the hardware logic is to:
receive a first set of data bits to be stored at a first location of the plurality of memory locations;
determine values of a set of code bits based on the first set of data bits;
write the first set of data bits and the set of code bits to the first location as first data;
determine, using the first data and first cumulative error data stored in the first register, second cumulative error data, wherein the first cumulative error data reflects previous data stored at the plurality of memory locations at a first time; and
overwrite the first cumulative error data in the first register with the second cumulative error data.

2. The memory device of claim 1, wherein to determine the second cumulative error data the hardware logic is to:
perform a first bitwise exclusive-or (XOR) operation using (i) the first data, and (ii) the first cumulative error data.

3. The memory device of claim 1, further comprising a second register, wherein the hardware logic is further to:
write the second cumulative error data to the second register; and
reset the first register to a default state.

4. The memory device of claim 1, wherein the hardware logic is further to:
receive a request to read second data from a second location of the plurality of memory locations, wherein the second data comprises a second set of data bits;
determine whether the second data contains a soft error;
responsive to determining the second data contains the soft error, perform an error correction operation;
determine whether the error correction operation removed the soft error from the second data;
responsive to determining the error correction operation did not remove the soft error from the second data, determine, from third data stored in the plurality of memory locations, third cumulative error data, wherein the third cumulative error data reflects the second data stored at the plurality of memory locations at a second time;
determine, using the second cumulative error data and the third cumulative error data, bit flip error data for the second data;
change a first data bit value of the second set of data bits based on the bit flip error data to obtain corrected second data; and
provide the corrected second data in response to the request to read second data from the second location.

5. The memory device of claim 4, wherein to determine the bit flip error data the hardware logic is further to perform a second bitwise XOR operation using (i) the second cumulative error data, and (ii) the third cumulative error data.

6. The memory device of claim 4, wherein each set of data bits corresponds to a plurality of bit positions, the hardware logic is further to:
determine, for each position of the plurality of bit positions corresponding to the plurality of memory locations, a respective number of bit errors; and
determine whether the respective number of bit errors satisfies a bit error criterion for each position of the plurality of bit positions,
wherein the determining the bit flip error data for the second data is responsive to determining the respective number of bit errors satisfies the bit error criterion for each position of the plurality of bit positions.

7. The memory device of claim 1, the hardware logic is further to:
receive a request to read second data from a second location of the plurality of memory locations;
determine whether the second data contains a soft error;
responsive to determining the second data contains the soft error, perform an error correction operation to obtain error-corrected second data;
determine whether the error-corrected second data satisfies a bit error criterion; and
responsive to determining the error-corrected second data does not satisfy the bit error criterion, performing a reset operation on the memory device.

8. A method comprising:
receiving a first set of data bits to be stored at a first location of a plurality of memory locations of a memory device;
determining values of a set of code bits based on the first set of data bits;
writing the first set of data bits and the set of code bits to the first location as first data;
determining, using the first data and first cumulative error data stored in a first register of the memory device, second cumulative error data, wherein the first cumulative error data reflects previous data stored at the plurality of memory locations at a first time; and
overwriting the first cumulative error data in the first register with the second cumulative error data.

9. The method of claim 8, wherein to determine the second cumulative error data, the method further comprising:
performing a first bitwise exclusive-or (XOR) operation using (i) the first data, and (ii) the first cumulative error data.

10. The method of claim 8, further comprising a second register, wherein further comprising:
writing the second cumulative error data to the second register; and
resetting the first register to a default state.

11. The method of claim 8, the method further comprising:
receiving a request to read second data from a second location of the plurality of memory locations, wherein the second data comprises a second set of data bits;
determining whether the second data contains a soft error;
responsive to determining the second data contains the soft error, performing an error correction operation;
determining whether the error correction operation removed the soft errors from the second data;
responsive to determining the error correction operation did not remove the soft errors from the second data, determining, from second data stored in the plurality of memory locations, third cumulative error data, wherein the third cumulative error data reflects the second data stored at the plurality of memory locations at a second time;
determining, using the second cumulative error data and the third cumulative error data, bit flip error data for the second data;
changing a first data bit value of the second set of data bits based on the bit flip error data to obtain corrected second data; and
providing the corrected second data in response to the request to read second data from the second location.

12. The method of claim 11, wherein to determine the bit flip error data, further comprising perform a second bitwise XOR operation using (i) the second cumulative error data, and (ii) the third cumulative error data.

13. The method of claim 11, wherein each set of data bits corresponds to a plurality of bit positions, the method further comprising:
determining, for each position of the plurality of bit positions corresponding to the plurality of memory locations, a respective number of bit errors; and
determining whether the respective number of bit errors satisfies a bit error criterion for each position of the plurality of bit positions,
wherein the determining the bit flip error data for the second data is responsive to determining the respective number of bit errors satisfies the bit error criterion for each position of the plurality of bit positions.

14. The method of claim 8, further comprising:
receiving a request to read second data from a second location of the plurality of memory locations;
determining whether the second data contains a soft error;
responsive to determining the second data contains the soft error, performing an error correction operation to obtain error-corrected second data;
determining whether the error-corrected second data satisfies a bit error criterion; and
responsive to determining the error-corrected second data does not satisfy the bit error criterion, performing a reset operation on the memory device.

15. A system comprising:
a memory device comprising a plurality of memory locations and a first register;
one or more processing devices operatively coupled to the memory device, the one or more processing devices to:
receive a first set of data bits to be stored at a first location of the plurality of memory locations;
determine values of a set of code bits based on the first set of data bits;
write the first set of data bits and the set of code bits to the first location as first data;
determine, using the first data and first cumulative error data stored in the first register, second cumulative error data, wherein the first cumulative error data reflects previous data stored at the plurality of memory locations at a first time; and
overwrite the first cumulative error data in the first register with the second cumulative error data.

16. The system of claim 15, wherein to determine the second cumulative error data, the one or more processing devices to:
perform a first bitwise exclusive-or (XOR) operation using (i) the first data, and (ii) the first cumulative error data.

17. The system of claim 15, further comprising a second register, wherein the one or more processing devices further to:
write the second cumulative error data to the second register; and
reset the first register to a default state.

18. The system of claim 15, wherein the one or more processing devices further to:
receive a request to read second data from a second location of the plurality of memory locations, wherein the second data comprises a second set of data bits;
determine whether the second data contains a soft error;
responsive to determining the second data contains the soft error, perform an error correction operation;
determine whether the error correction operation removed the soft errors from the second data;
responsive to determining the error correction operation did not remove the soft errors from the second data, determine, from second data stored in the plurality of memory locations, third cumulative error data, wherein the third cumulative error data reflects the second data stored at the plurality of memory locations at a second time;
determine, using the second cumulative error data and the third cumulative error data, bit flip error data for the second data;
change a first data bit value of the second set of data bits based on the bit flip error data to obtain corrected second data; and
providing the corrected second data in response to the request to read second data from the second location.

19. The system of claim 18, wherein to determine the bit flip error data, the one or more processing devices further to perform a second bitwise XOR operation using (i) the second cumulative error data, and (ii) the third cumulative error data.

20. The system of claim 18, wherein each set of data bits corresponds to a plurality of bit positions, the one or more processing devices further to:
determine, for each position of the plurality of bit positions corresponding to the plurality of memory locations, a respective number of bit errors; and
determine whether the respective number of bit errors satisfies a bit error criterion for each position of the plurality of bit positions,
wherein the determining the bit flip error data for the second data is responsive to determining the respective number of bit errors satisfies the bit error criterion for each position of the plurality of bit positions.

21. The system of claim 15, the one or more processing devices further to:
receive a request to read second data from a second location of the plurality of memory locations;
determine whether the second data contains a soft error;
responsive to determining the second data contains the soft error, perform an error correction operation to obtain error-corrected second data;
determine whether the error-corrected second data satisfies a bit error criterion; and
responsive to determining the error-corrected second data does not satisfy the bit error criterion, performing a reset operation on the memory device.

22. A system for high-speed network communication, the system comprising:
one or more processing units; and
a network interface coupled to the one or more processing units, wherein the network interface comprises a transmitter device and a first controller coupled to the transmitter device, wherein the transmitter device to transmit a data signal via a communication network, the first controller to:
receive a first set of data bits to be stored at a first location of a plurality of memory locations of a memory;
determine values of a set of code bits based on the first set of data bits;
write the first set of data bits and the set of code bits to the first location as first data;
determine, using the first data and first cumulative error data stored in a first register, second cumulative error data, wherein the first cumulative error data reflects previous data stored at the plurality of memory locations at a first time; and
overwrite the first cumulative error data in the first register with the second cumulative error data.

23. The system of claim 22, wherein to determine the second cumulative error data, the one or more processing units to:
perform a first bitwise exclusive-or (XOR) operation using (i) the first data, and (ii) the first cumulative error data.

24. The system of claim 22, further comprising a second register, wherein the one or more processing units further to:
write the second cumulative error data to the second register; and
reset the first register to a default state.

25. The system of claim 22, wherein the one or more processing units further to:
receive a request to read second data from a second location of the plurality of memory locations, wherein the second data comprises a second set of data bits;
determine whether the second data contains a soft error;
responsive to determining the second data contains the soft error, perform an error correction operation;
determine whether the error correction operation removed the soft errors from the second data;
responsive to determining the error correction operation did not remove the soft errors from the second data, determine, from second data stored in the plurality of memory locations, third cumulative error data, wherein the third cumulative error data reflects the second data stored at the plurality of memory locations at a second time;
determine, using the second cumulative error data and the third cumulative error data, bit flip error data for the second data;
change a first data bit value of the second set of data bits based on the bit flip error data to obtain corrected second data; and
providing the corrected second data in response to the request to read second data from the second location.

26. The system of claim 25, wherein to determine the bit flip error data, the one or more processing units further to perform a second bitwise XOR operation using (i) the second cumulative error data, and (ii) the third cumulative error data.

27. The system of claim 25, wherein each set of data bits corresponds to a plurality of bit positions, the one or more processing units further to:
determine, for each position of the plurality of bit positions corresponding to the plurality of memory locations, a respective number of bit errors; and
determine whether the respective number of bit errors satisfies a bit error criterion for each position of the plurality of bit positions,
wherein the determining the bit flip error data for the second data is responsive to determining the respective number of bit errors satisfies the bit error criterion for each position of the plurality of bit positions.

28. The system of claim 22, the one or more processing units further to:
receive a request to read second data from a second location of the plurality of memory locations;
determine whether the second data contains a soft error;
responsive to determining the second data contains the soft error, perform an error correction operation to obtain error-corrected second data;
determine whether the error-corrected second data satisfies a bit error criterion; and
responsive to determining the error-corrected second data does not satisfy the bit error criterion, performing a reset operation on the memory.
